(19) United States
(12) Patent Application Publication
(10) Pub. No.: US 2021/0303116 A1
(43) Pub. Date: Sep. 30, 2021

(54) Providing Notes and Marking for a URI from a Context Group Container

(71) Applicant: Platstack, LLC, South Jordan, UT (US)

(72) Inventor: Eslee Buckley Barlow, Bluffdale, UT (US)

(21) Appl. No.: 16/830,245

(22) Filed: Mar. 25, 2020

(51) Int. Cl. G06F 3/0483; G06F 3/0486; H04L 29/08; G06F 40/169

(52) U.S. Cl. CPC G06F 3/0483; G06F 40/169; H04L 67/02; G06F 3/0486

(57) ABSTRACT

Technology is described for a method for presenting a note for a URI (Universal Resource Identifier) linked with a context group container. The method may include displaying the context group container with a plurality of URIs that are accessible via an application. The context group container may have a context topic description and topic title for the plurality of URIs. A selection of a URI for the context group container may be received. Notes and URI markers that are associated with URI in a data store may be retrieved. Another operation may be opening the URI in the application to display URI contents. A note for the URI in the application may be displayed in a user interface control viewable with the URI in the application. A URI marker may be displayed which marks a portion of content of the URI and associates the note with the URI marker.

### BACKGROUND

Vast amounts of personal, public and private information are stored on computers around the world. Much of this information is available via web sites or on the internet, and this array of information is accessible using internet connections, wireless connections, or similar computer networking connections. These massive amounts of information may be stored across private servers, public servers, cloud storage, network attached storage systems (NAT systems), or any number of other electronically accessible storage technologies.

Many pieces of information may be accessed through a computer network using a URI (Universal Resource Identifier), URL (Universal Resource Locator) or another linking technology that allows users to view digital content or media content using a network address. The use of URI's may provide access to individual information, such as web pages, videos, audio recording, images, text files, spread sheets, executable images, binary data or many other types of information that may be accessible using a browser.

### BRIEF DESCRIPTION OF THE DRAWINGS

FIG. 1A illustrates a user interface to create a context group container for a plurality of URIs (Universal Resource Indicators) which are moved into the group context container.

FIG. 1B illustrates a user interface using a list with a copy of open tabs to create a context group container for a plurality of URIs (Universal Resource Indicators) which may be moved into sections of a group context container.

FIG. 1C illustrates a user interface using open tabs to create a context group container for a plurality of URIs (Universal Resource Indicators) which may be moved into sections of a group context container.

FIG. 2A illustrates a user interface to send a URL for a context group container to other users or groups of users over a computing network.

FIG. 2B illustrates a user interface to select a sub-set of URIs in a context group container to send to a recipient.

FIG. 3 illustrates a user interface to create a context comment for URIs (Universal Resource Indicators) which have been added into the group context container.

FIG. 4A illustrates a user interface for adding notes to an electronic page or URI in a context group container that are viewed as notes with a callout in a plug-in that is viewable in a border of an electronic page or browser.

FIG. 4B illustrates a user interface for adding notes to a URI that is a video from a context group container and the notes are viewed with a callout in a border of an electronic page or browser.

FIG. 4C is a flowchart illustrating a method for presenting a note for a URI (Universal Resource Identifier) stored in a context group container.

FIG. 5A illustrates an example of a system and related operations for finding a URI stack or context group container using a query.

FIG. 5B is a flowchart illustrating an example of a method for storing a plurality of URIs (Universal Resource Identifier) in a context group container.

FIG. 6 is a block diagram that illustrates an example service provider environment that includes computing resources for creating and storing a context group container.

FIG. 7 is block diagram illustrating an example of a computing device that may be used to execute a method for creating a context group container.

### DETAILED DESCRIPTION

One side effect of the vast amount of data stored across a massive number of servers or other storage systems across the world is that this large amount of digital information is becoming disorganized over time at a personal level, a company level, and even a global level. As time passes, nearly every aspect of our lives and the actions we take is recorded electronically. However, the digital clutter and digital disorganization that occurs when valuable data is stored to various locations and disparate websites becomes more apparent every day. Even the meaning of data from different sources which is spread across many locations becomes more difficult to discern (especially on the internet), and meaningful data for a specific topic becomes more difficult to find due to the almost unlimited amount of data that is becoming available. In addition, the accuracy of much of the data or information on the internet is also difficult to judge.

For example, digital clutter often means that finding a significant amount of directly useful information on a specific topic may often be quite difficult. A researcher may find one or two links or electronic pages on a specific topic by using a search engine. However, finding a significant amount of information on a specific detailed topic, especially technical or engineering topics, can be quite difficult. Researchers may ask themselves certain question about the information they find in researching. “Are the links a researcher found a good place to start, and do the links represent beginning, intermediate or advanced aspects of a topic? Are the links factual information?” These questions and other similar questions can be difficult to answer. Examples of highly technical topics where finding relevant resources on the topic is important may include: computer science, mechanical device repair, electronic device repair, computer technical support, vocational training, detailed hobbies and other areas where a single link or a single line answer from a search engine may not be enough to satisfy what the researcher is trying to find or become a greater expert in.

Another example of electronic disorganization is that every person with an electronic device has data spread across a wide variety of storage locations. For example, users may have data that is accessible on a local network, in a private cloud, in a public cloud, through multiple web applications at work, in multiple customer applications, in vendor applications, at internet website, in blogs, in social media, etc. Such large amounts of digital data can be difficult to organize and even reference again once the data has been created by or on behalf of a user.

Further, the large amounts of information available on a vast number of servers and on the internet has made sorting through such information increasingly harder and finding relevant information even more difficult as more data is created and more time passes by. The amount of data that has become cluttered and disorganized is growing dramatically as time passes in the digital age and the ability to find desired information within that massive amount of data is not improving.

The present technology provides a way to organize or reference very focused amounts of information that a user wants to manage and maintain as the user collects information on the internet, in public clouds, on websites, in web applications, and in other information repositories with data objects or executable objects that can be referenced using URIs and URLs or any other link accessible digital objects.

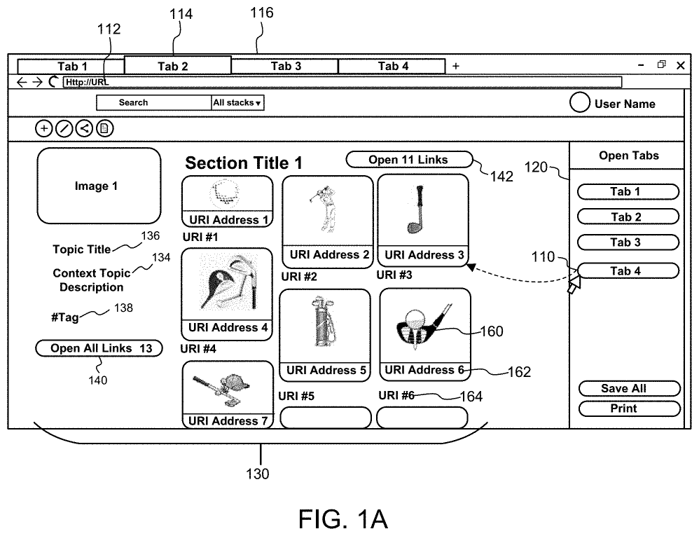

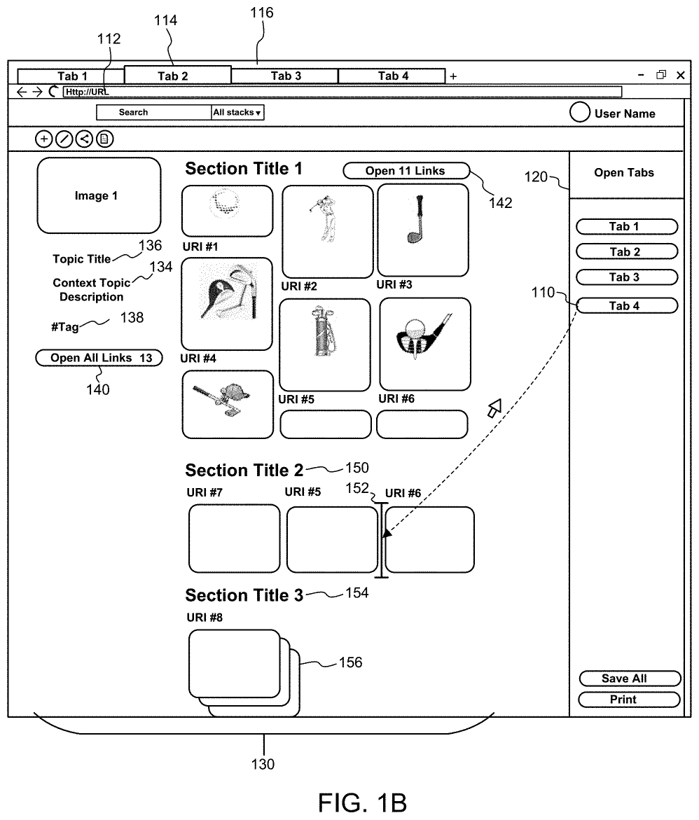

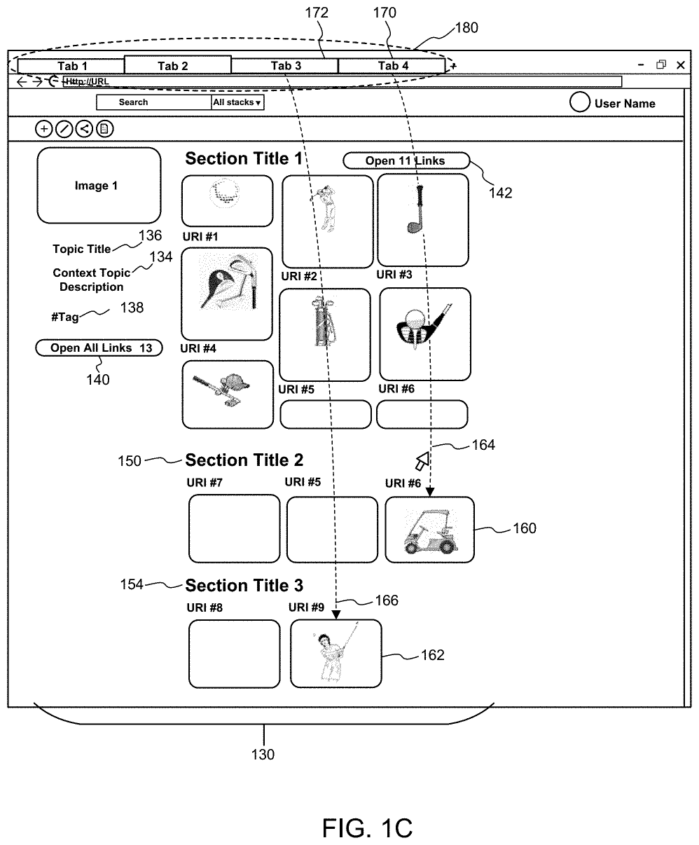

FIG. 1 illustrates a technology and user interface to create a context group container for a plurality of URIs (Universal Resource Indicators). This context group container may be considered a stack of URIs. Examples of the URIs may be URLs (Universal Resource Locator) that access a resource on the internet via HTTP(S) or a similar internet protocol. The resource may a web page, a video, an audio file, an image, a data file, an executable program, a web application page, or other electronic objects and media resources with URLs.

The technology may be executing on a client device or another mobile computing device that includes at least one processor. A memory device may be included with the processor that includes instructions which when executed by the at least one processor, causes the system to perform functions. A client device may include any device capable of sending and receiving data over a network. A client device may be a device such as, but not limited to, a desktop computer, laptop or notebook computer, tablet computer, mainframe computer system, handheld computer, workstation, network computer, or other devices with like capability. A mobile computing device may be a mobile phone, a mobile table with a wireless connection, an in-vehicle mobile device, or a similar mobile device.

FIG. 1 illustrates that electronic pages or electronic media items associated with a URI or URL 112 may be loaded in a multi-pane interface of a browser 116 using multiple tabs 114 and these URIs or URLs may be identified by obtaining the URI information from the browser. For example, the browser may identify one or more of the open tabs in the browser. A URI user interface object 110 for the URI or URL may be displayed in a list interface control 120 in the browser 116. The URI user interface object(s) 110 may be for the URI(s) or URL(s) that is loaded (e.g., being viewed or browsed) in a tab and is also displayed in the list interface control 120. The URI user interface object may be a copy of a URI in a tab and may be displayed as an image, text, mini-banner, button, check box with associated text, radio button with text or another user interface control representing the URI being viewed. The term URI will be used in this discussion and any reference to a URL is simply as a subset of the more generalized link type provided by URIs.

A context group container 130 may be displayed, and the context group container 130 may be capable of storing a copy of the URI selected in the list interface control 120 with a plurality of other URIs in the context group container 130. The context group container 130 may also include a context topic description 134 for the plurality of URIs. The context topic description 134 may define context topic for a context group container 130 or a stack of URIs. The context topic description 134 may be a description of a topic grouping for which the URIs are being collected. In addition, the topic may have a topic title 136 which may be considered part of the context topic description 134 or may be an independent field in the data store. For example, the context topic description 134 may be “A collection of the best golf drivers tested on the golf course.” and the topic title may be “Best Golf Drivers”. The context group container 130 may also include context tags 138 for the context group container. The context tags 138 may include tags that provide additional terms, tag lines, promotional terms or other text for searching or referencing the context group container 130.

The URI or URL can be moved to the context group container 130 when a graphical dragging and dropping user interface control is used to move the URI viewed as a URI user interface object 110 from the list interface control 120 into the context group container 130. For example, the URI or URL addresses of one or more of the tabs in the browser opened by the user may be displayed in the list interface control 120 or the open tabs listing control. The user may select a URI that the user wants to move to the context group container 130 using a graphical selector or pointer. A graphical pointer on the graphical user interface (GUI) and a hardware pointing device may be used to assist with identifying the target image, text or button. The hardware pointing device may be a mouse pointer, a touch screen, a stylus or another hardware pointing device.

Then the dragging and dropping operation may be used to drag the URI from the list interface control 120 into the area used to represent the context group container 130. More specifically, the URI can be dragged to an area where other URIs for the context group container 130 may be displayed. The URI can be added to the end of a list of URIs or the URI can be added into the list of URIs at a point in the list where the user places a graphic cursor for the list. Thus, the URI can be inserted into the group of URI at the point selected by the user.

Alternatively, the URI can be added to the context group container 130 using other graphical operations besides a drag and drop operation. For example, a user may select a desired representation of a tab by selecting the URI in the list interface control 120. A user's selection may be displayed using: highlighting, a check box or another graphical selection representation. The user may then select the visual point in the context group container 130 where the user wants the URI to go or the user may select any visual point in the context group container 130 and the transfer operation may take place. The transfer operation may also be initiated by clicking a separate button to move the URI into the context group container 130 or use another graphical move operation.

Other types of graphical user interface (GUI) operations may be used to move the URIs from the list interface control 120 to the context group container 130. For example, on a mobile device, using a finger depression operation (e.g., a long touch or force touch with pressure sensors) on the mobile device may move the URI to the context group container. Similarly, a click and hold operation on mobile device, a selection (press once) until haptic feedback or haptic touch (e.g. selection until mobile device vibration) occurs may be used to move the URI to the context group container. On a mobile device, “transparent icons” or swipe up or swipe down functionality can be used indicate that a URI should be added to a context group container. Similarly, swiping up or down may result in a vote for the context group container or stack and define whether the user likes the context group container.

In a further user interface alternative, a user may drag and drop a tab in the web browser directly into the context group container to add the URI to the context group container. The user may drag an active tab or an inactive tab into the context group container. Similarly, there may be a button, hot spot, graphic or image on the tab that may be depressed (pressed once) and then held until haptic feedback occurs and then the URI may be moved to the context group container. Any type of long touch, haptic touch, force touch or similar interface control may be used in moving a tab to the context group container

FIG. 1B further illustrates that the URIs may be added to one of multiple different sections 150 of the context group container 130. In one configuration, the URI may be added to a section 150 (e.g., Section Title 2) that is the second of two sections in the context group container 130. This list of URIs may be displayed as “graphical cards” that are sized to display an image associated with the URI and the graphical cards may be laid out side-by-side.

Alternatively, the URIs may be listed in a stacked or tiled fashion where the top URI in the stack is active and the edges of the tiled URI can be clicked on to see the next URI in the stack. A third section of FIG. 1B illustrates “Section Title 3” where the URI's are tiled in a sub-stack 156 and any URI tile in the sub-stack can be surfaced by clicking the edge of the URI tile.

In addition, the URI can be added into a specific location in a section 150 with a list of URIs in the context group container 130. For example, the URI can be directed into a desired location in the list of URIs using a cursor pointer 152. The location and ordering of the URIs in a section or a context group container 130 also provides context. The context of the URI in a section is derived from the section header, and the ordering of the URI in the section list of URIs provides a ranking against other URIs in the section. For example, a URI listed first in the ranking may be most important to a user, whereas, the URI listed last in the section may be of least significance to the create of the section. In addition, the URI also has the relation of the section to the context grouping container. The section titles may be customized and may include a section name for a section of the URIs. For example, the section titles may be a day of the week (e.g., Monday, Tuesday, Wednesday, etc.), a sub-topic related to the topic title 136 (e.g., topic title=“firearms”, section titles=“pistol”, “rifle”, “automatic”, etc.).

The URIs that are added to the context group container 130 may be stored in a data store managed by the context group application. For example, the URIs may be stored in data store in a service provider environment (e.g., a cloud computing service provider) as grouped by the topic description. The URIs may be stored in a relational database, a NoSQL database (e.g., in XML form), an object data store (e.g., S3 at Amazon or Google Cloud Storage), an object-relational database, a flat file, or another storage format. Alternatively, the URIs may be stored in a hardware server in a LAN (local area network) or WAN (wide area network) and the URIs and the context group containers may be accessed by the users who have security rights to the local network.

The URIs may be displayed with the plurality of URIs that are associated with the context topic description 134, as illustrated in FIG. 1A. The URIs may display an associated image 160 along with the context topic description 134 on the electronic page or web page displaying the context group container 130. If the user activates the image 160 on the web page (e.g., by clicking on the image or selecting and opening the image), then the URI may be opened in another browser tab or a new pane in the browser. Alternatively, the user may activate or click on a URI address 162 which may open the UR in another browser tab, another window, or a browser pane. Similarly, the user may activate or click on a URI title 164 which may open the UR in another browser tab, another window, or a browser pane. The URI address 162 or URI title 164 may or may not be part of the image or tile representing the URI.

The user interface of FIG. 1A, further illustrates a user interface control or multi-open button 140 to enable a plurality of URIs in the context group container to be opened using a single activation action on a user interface control. For example, the user interface control may be button, text, a check box, a radio button, a list box or another control that receives a single activation action and opens multiple URIs with a single activation (e.g., left click). When a multi-open button 140 is activated clicked by the user the URIs in the context group container may be opened as tabs in the browser or in separate panes of a browser or application.

Alternatively, a multi-open button 142 may be associated with a section of URIs in the context group container 130 and the button may open the URIs in that section of the container. For example, a context group container 130 may contain 30 URI representations and a section of the context group container 130 may contain 5 URIs or URI tiles. Accordingly, when the multi-open button 142 or group open button of the section is clicked then 5 URI representations may be opened in browser tabs of the browser.

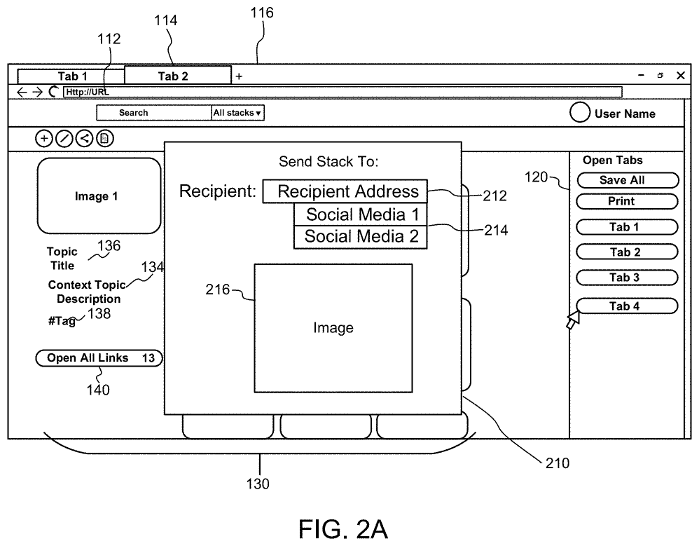

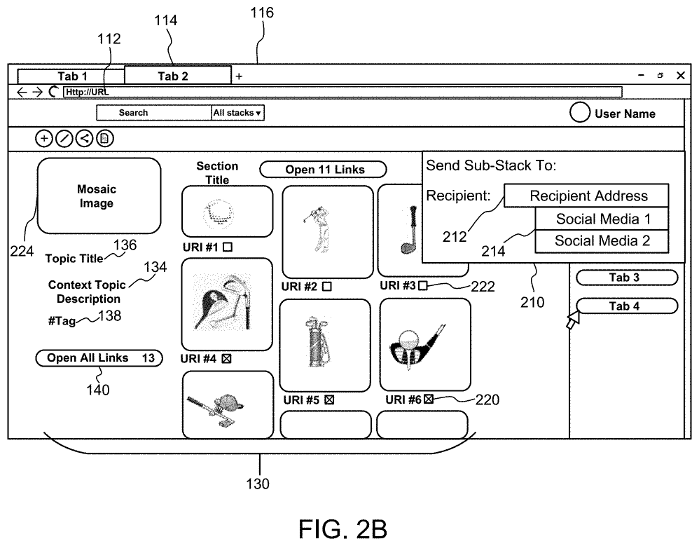

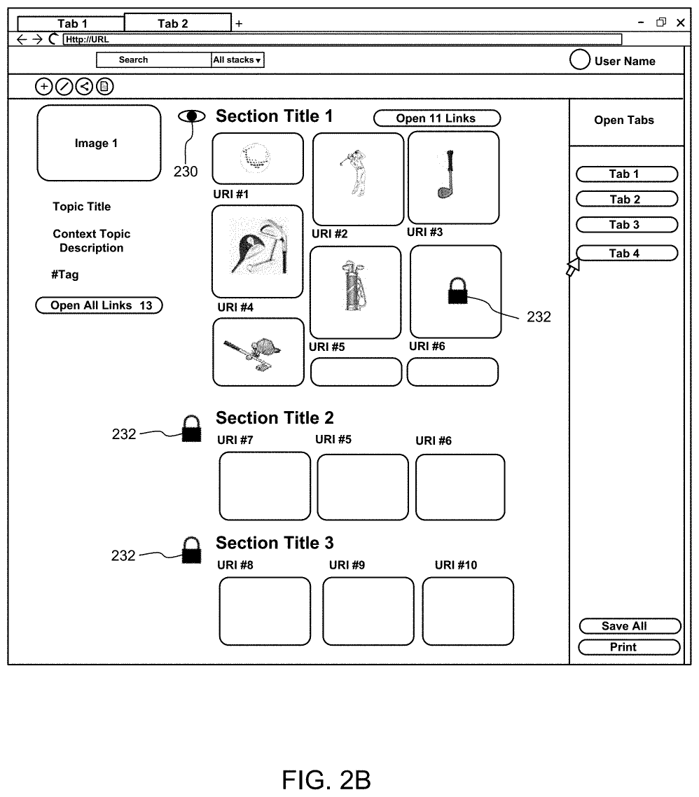

FIG. 2A illustrates that a URI reference to the context group container 130 can be sent to a recipient to enable the recipient to view the context group container 130. A reference to the context group container can be sent to one or more recipients (e.g., an individual or a group of recipients) to enable the one or more recipients to view the context group container through a browser or application. FIG. 2A illustrates a modal window 210 or another interface which may be presented to enable a user or creator of the context group stack to enter an address or account to send the context group container 130 to one or more other users. The interface for sending the URI or URL for the context group container 130 may be a modal window 210, drop down window, overlay window, popup window, or user interface control to enable a user to enter a URL, an address (e.g., an email address), group identifier (e.g., social media group), or another recipient identifier into a text box 212.

In one configuration, a drop-down list 214 may be a user interface control that is used to present types of social media to which a context group container may be sent. For example, a user may select to send a URI or for the context group container 130 to a social media account such as FACEBOOK, TWITTER, INSTAGRAM, YOUTUBE or another social media platform with social capabilities. The URI or URL for a context group container 130 may be sent to an individual user on the social media platform or to a group on the social media platform. Similarly, the URL may be sent to a communication system that provides feeds to other users. This may be a web feed, an active feed on a web site, a news feed, a data feed in the cloud, a feed on a blog, or any other type of data feed. An image 216 representing the context group container may also be displayed in the modal window or user interface control. Alternatively, the user interface controls for the social media or other grouping interfaces may be buttons which activate a separate interface or window to send the URI to the recipient(s).

The URL or URI for the context group container 130 may then be sent to the user or group of users who can access the URL and open the electronic page for the context group container 130 that is provided from a web application server or through an application loaded on a client. In one example, a reference to the context group container 130 can be sent to an electronic channel for context group containers 130 to enable viewers or subscribers to the channel to view the context group container.

FIG. 1C further illustrates that a URI may be added into a context group container 130 by moving a tab 170 from a browser (or another executing application) into the context group container 130. As illustrated, the tab 170 may be moved 164 from the list of tabs (e.g., a list interface control 120) to a section 150 of the context group container 130 desired by the user, and this move operation may create a URI entry 160 or URI tile with an image in the context group container 130. In another example, a second tab 172 may be moved 166 to another section 152 of the context group container 130 to create a URI entry 162 with an image representing the URI. The moving of the URI into the context group container 130 may be a graphical drag and drop operation. Other types of graphical user interface (GUI) operations may be used to move the URIs from the group of tabs 180 that is a list interface control to the context group container 130. For example, on a mobile device, using a finger depression operation (e.g., a long touch or force touch with pressure sensors) on tabs in a mobile device may move the URI to the context group container. Similarly, a click and hold operation on a tab in a mobile device or a selection (press once) until haptic feedback or haptic touch (e.g. selection until mobile device vibration) occurs may be used to move the URI to the context group container 130. On a mobile device, “transparent icons” or swipe up or swipe down functionality can be used on a tab to indicate that a URI should be added to a context group container 130.

The term list interface control has been illustrated as being a list of tabs in the top of a browser interface or a list of open tabs copied to a list at a side or bottom of a browser or application. In the alternative, the list interface control may display a list of large icons, small icons, text or other lists representing opened (active or inactive) URIs that may be copied to the context group container. While the URIs may represent URIs being actively browsed or viewed, the URI may also be archival lists of URIs or URIs from other context group containers or stacks that are displayed to enable the URIs to be moved from one stack or context group container to another. While this list control interface has been illustrated in a linear format, the list control interface may present a list of URIs to a user in a circular, rotating, three-dimensional, depth based, tree, graph, or other geometric format while still maintaining the functionality provided in this description.

FIG. 2B illustrates a user interface to enable a user to select a sub-set of URIs in a context group container to send to a recipient. The URIs or links may be selected using a user interface selection mechanism such as: a check box (e.g. a marked checkbox 220 may illustrate selection and an unmarked checkbox 222 may indicate omission from a group), radio button, highlight, graphical marker, and image marker or another way of designating the URI as being selected. These multiple links may be sent to a recipient using one link. The system may send the sub-set of links using a temporary web page, embedded in an email or another landing page where the user can view the sub-set of links. The interface presenting or describing sub-set of may also reference the main context group container from which the sub-links were selected. In this configuration the user does not get the other links in the context group container. An image mosaic 224 with 2 or more images representing URI in the context group container may be sent to a recipient and when the recipient receives the image mosaic the recipient may select and open links by selecting portions of the image mosaic 224 representing certain URIs. Alternatively, automatic selection of a sub-group of links may be designated using a keyword, value, or other type of URI filtering method.

A reference to the sub-group or sub-stack can be sent to one or more recipients (e.g., an individual or a group of recipients) to enable the one or more recipients to view the context group container through a browser or application. FIG. 2B illustrates a modal window 210 or another interface which may be presented to enable a user or creator of the sub-stack to enter an address or account to send the sub-stack 130 to one or more other users. The interface for sending the URI or URL sub-stack may be a modal window 210, drop down window, overlay window, popup window, or user interface control to enable a user to enter a URL, an address (e.g., an email address), group identifier (e.g., social media group), or another recipient identifier into a text box 212. The sub-stack or sub-group of links may be sent to social media accounts using a drop-down list 214 as discussed in FIG. 2A.

FIG. 2C illustrates making portion of a context group container private. If a user that is a creator of a context group container or stack only wants to share a certain portion of the context group container or stack, then a first portion of the stack may be made public as illustrated by the eye icon 230. However, another portion of the stack may be kept secret or inaccessible as illustrated by the lock 232. More specifically, the URIs and links in a section may not be opened when they are locked or all the URIs in a section may be hidden from view when the section is locked. Similar protections may be provided on at a URI 232 or link level also.

If a second user wants access to the links or the sections, then a request may be made to creator of the context group container. The creator of the context group container may provide access when a payment is made to the creator. Alternatively, the creator may provide access to a requesting user simply upon request and the creator may provide a token, credentials, or a password that allows the second user to access the locked content. Providing access to only a portion of the context group container may allow artists, writers, musicians, vloggers and other to put out free content on a specific topic title but then request payment for premium content that the creator provides.

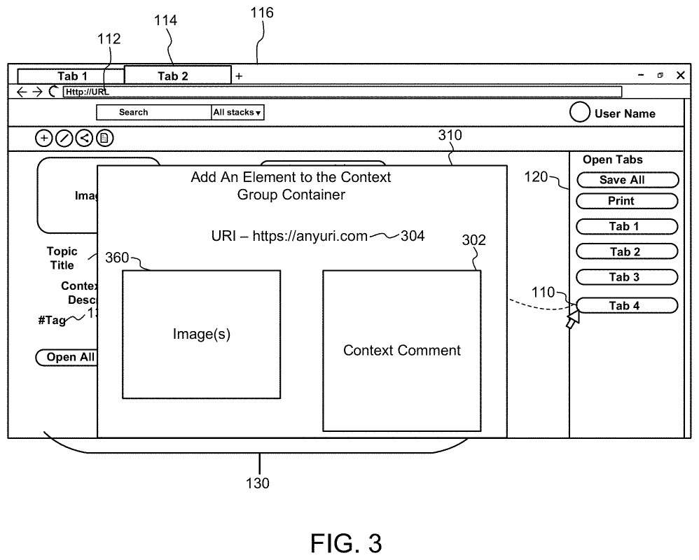

Now turning to FIG. 3, when a URI is moved into the context group container 130 via: a drag and drop, a selection and move operation or when the URI is added to the context group container 130 via typing the URI, the graphical user interface may present an interface to receive a context comment 302 for the URI from a user. The graphical interface may display the URI 304 and an image 360 for the URI to be added to the context grouping container 130 or stack in a modal window 310. Accordingly, a user may type in a context comment 302 to be stored and associate with the URI being added to the context group container 130. The context comment 210 may explain a reason why the URL is to be added to the context group container. For example, a URI may be added that is a video, and the user may wish to direct the user to time mark 5:45 in the video because this portion of the video relates directly to the context topic description 134 for the group of URIs. The interface illustrated in FIG. 3 for obtaining a context comment 302 may also be opened for any existing URI and the context comment 302 may be edited by the creator of the stack desires.

The context comment 302 and the URL 304 may be linked together and stored in a data store that is on a server. The server may reside locally on a private server or in a server in a public service provider environment or cloud provider. The context comment 302 may be stored with a reference to the URI so that when the URI is retrieved the context comment can also be retrieved and displayed along with the URI.

FIG. 3 illustrates the user interface for capturing the context comment 302 may be a modal window, a text box, pop-up window, an editor or some other user interface control that can accept a context comment 302 of any length for a URI. The context comment 302 received from a user about a URI can be captured using the user interface control. The context comment 302 is captured in order to explains a relationship between the context topic and the URI or other URIs. In addition, the context comment and URI may also be linked to the group context container 130 because this is the context within which the URI has contextual value. More specifically, the context comment 302 can be stored with a reference or pointer to the URI or context group container 130. This may be done using a data store key, a pointer or another linkage in a data store.

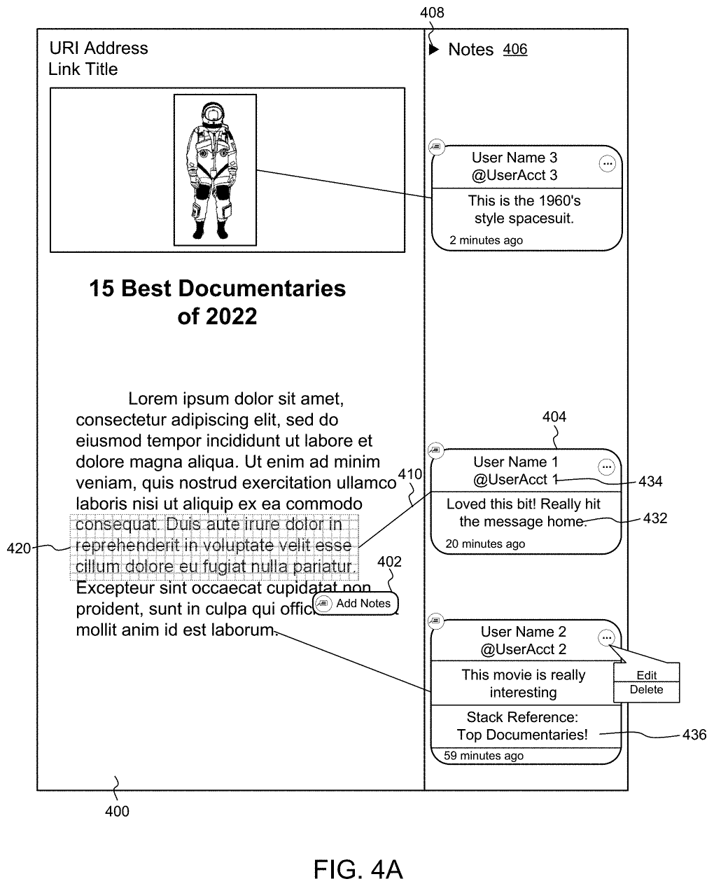

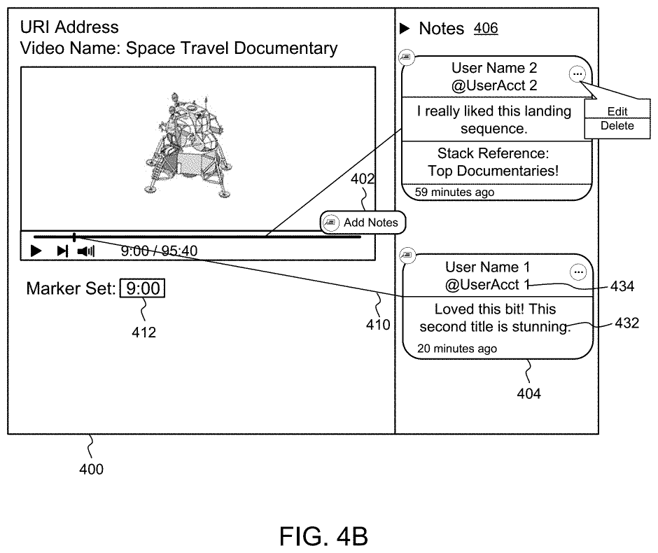

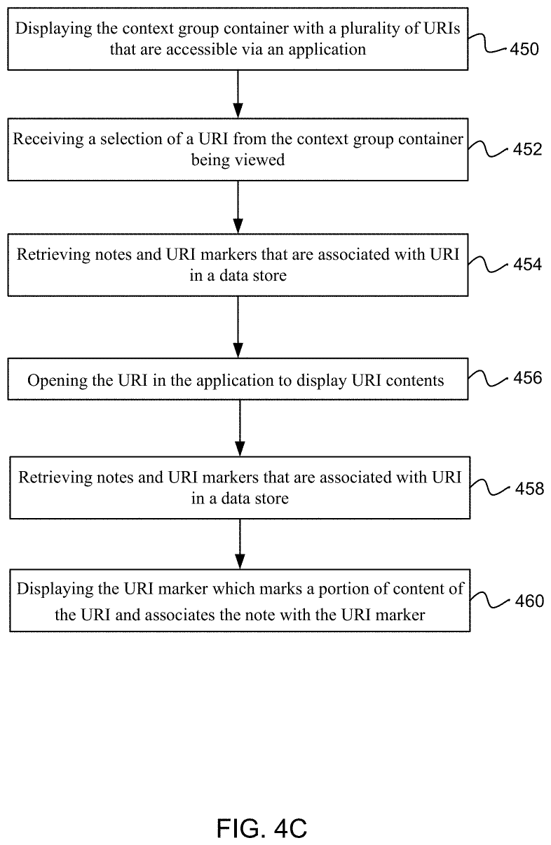

FIG. 4A illustrates that notes 406 may be captured for an electronic page 400 (e.g., web page) which are stored notes 406 for a URI reference in the context grouping container 130 (FIG. 1). A note 404 can be displayed with a callout 410 regarding a URI being viewed. The callout 410 can reference a displayable portion of the electronic page (e.g., a web page, image, web application, etc.) that may be highlighted 420 or otherwise marked as separate from the remainder of the content or media content. In addition, the note 404 can be displayed in a notes column 406 next to the electronic page which may be opened and closed using a user interface open and close arrow 408 to slide the notes column open or closed. For example, the note 404 can be displayed in a sidebar created by a plugin (for managing the context group containers) of a browser when the URI or URL is opened in the viewing interface. The sidebar viewing interface may be opened when the URI or URL is selected or clicked from the context group container. For example, the notes view may be activated in FIG. 1 using a menu (e.g., a right click menu or another context menu) associated with the URI or URL stored in the context group container. Alternatively, an icon can be overlaid on the image representing the URI in the context group container. The icon may be a symbol representing a note, a marker, or a comment and may be partially transparent. A user viewing the image for the URI can then click on the icon on the URI image and the link will be opened and the notes, highlights and/or markers for specific areas or markers in the URI may be displayed.

The note 404 may contain a comment 432 or note from a user which discusses a portion of an electronic page. The note 404 or comment may explain why the portion of the electronic page or electronic media is interesting the user, or the user may simply direct attention to the passage (e.g., “Look at this.”). The note 404 may reference the user 434 who created the note using the user's login to the context group container management system. The note may also contain a reference to the context group container, stack, or URI with which the comment is associated 436. For example, the web page may reference documentaries and the context group container or stack from which the web page was drawn may have the context topic description of “Top Documentaries!”.

The note 404 can be stored with a context record for a URL in the context group container. In other words, a URL can have context record that links the notes to URL and the URL and also linked to context group container. In this configuration, the note 404 is related to the URL and the URL is stored in the context group container. The electronic page may be loaded from any data store accessible via HTTP and the internet (e.g., from the source website). However, the notes 404 may be loaded from a data store that can track the relationship of the notes to the URI and in turn the relationship to the context group container. Accordingly, the notes 404 are displayed when the electronic page or web page is accessed from the context group container. If the electronic page is loaded using the address bar or a link from an unenhanced web page, then the notes will not be viewable.

This context hierarchy provides context for the URI. This context is a granular user level of interest in context associated with the context group container, context topic description and topic title associated with the context group container. For example, context is provided for portions of the URI (e.g., portions of the electronic page or web page) which are relevant to the users who are viewing the subject matter contained in the URI as related to the context group container. This allows a user to access very detailed portions of a URI without reading or consuming the entire URI as the URI relates to the context group container.

FIG. 4B illustrates a user interface 400 for adding 402 notes 406 to a URI that is a video in a context group container and the notes 406 may be viewed with a callout 410 in a plug-in that is viewable in a border of an electronic page or browser. If a user highlights, marks, or sets 412 a time point that is the second title of a video (e.g., a 9:00 minute point) upon saving the URI into the context group container, when the URI is opened from the context group container then the user interface, a pane in the browser or a modal window can display the time point that represents the first title as previously marked. In addition to the marking a time point on the video, a user 434 can provide a note 432 for the point that was marked. These notes, comments and marking for annotating content in URIs can also apply to audio tracks, an audio playlist, an image, a data file, a spreadsheet, a linked email, an application or any other data object or executable object that may be referenced by a URI. For example, a creator of a stack may create a URI that points to a playlist of songs, then the creator can mark and annotate one song in the list. When the URI is opened again, the marker can take a user to the point where the audio playlist was marked (i.e., the individual track) and display the note or other annotation. A custom browser may also be provided to support the notes annotations in a native format, without using a plugin.

The notes 406 and comments that may be added for URIs (e.g., notes or comments on web page) may be added at the time the URI is added to the context group container. For example, a user can select a URI to add to the context group container and then add a note in an insert window when the URI is being added to the stack. When a URI record is being created for a context group container, the user can also enter information for the URI such as notes, context, descriptive titles, and reminders and this information can be added along with the URI being added to the context group container.

FIG. 4C is a flowchart illustrating a method for presenting a note and URI marker for a URI (Universal Resource Identifier) stored in a context group container. The method may include the operation of displaying the context group container with a plurality of URIs that are accessible via an application, as in block 450. The context group container may have a context topic description and topic title for the plurality of URIs, as described earlier. The URIs may be grouped by the context topic description (either by the explicit topic (e.g., golf) or simply by the naming of the group container, e.g., John's 20 favorite unrelated links) and the URIs, notes and URI markers may be stored in a data store in a service provider environment or cloud environment in a format that references the context group container and the context topic description. For example, the context group container and the related URIs, notes, and URI markers may be stored as XML, in a NoSQL database or in a relational data store organization.

A selection of a URI for the context group container being viewed may be received, as in block 452. In addition, the notes and URI markers that are associated with URI in a data store may be retrieved, as in block 454. The URI may be opened in the application or browser to display the URI contents, as in block 456. The URI may be: a web page, a video, an audio track, a podcast, an audio playlist, an image, a data file, a spreadsheet, an email, an application, a data object or an executable object that is being referenced by the URI.

A note for the URI may be displayed in the application or browser in a user interface control viewable with the URI in the application, as in block 458. The note may include a user name, user text comment, user recorded audio, user recorded video and/or a timestamp. A callout between the note and the URI marker may be a graphical reference between the note and URI marker. For example, the callout may be a line between the note and the URI marker. Alternatively, the callout may be another graphical linkage such as a graphical arrow, a graphical chain, corresponding reference numbers, a graphical dotted line for visual fencing, or another visual linkage between the note and URI marker. The callout may be linked to the note or the URI marker or both.

The URI marker which marks a portion of content of the URI and associates the note with the URI marker may also be displayed, as in block 460. The URI may be marked using a URI marker that is a graphical highlight to mark a portion of text in the URI (as in FIG. 4A). In another example, the URI may be marked using a URI marker that is a graphical highlight to mark a portion of an image in the URI. This may be a two-dimensional highlighting on a two-dimensional (2D) portion of an image or a three-dimensional highlight on a three-dimensional (3D) portion of an image. In the situation where a URI that contains video, the URI may be marked using a URI marker that is a time marker for a video and the note include text or other media comments about the video. Other types of URI markers may be a time marker for an audio file, a image marker with graphical annotations, a spatial marker for a 3D environment enclosing 3D structures in the 3D environment, a visual for marker marking a portion of an interface of an application (e.g., marking important parts of data or controls in an application or explaining how to use an application).

The URI may be opened in a graphical user interface of: a viewing pane or a tab of an application that is a browser, an electronic page of an application or an electronic page of a mobile application. The browser or application may have the data loaded from the selected URI from the context group container and the URI marker and note associated with the URI may be displayed together in the same browser or application at the same time. For example, the note may be displayed in a sidebar in a browser and the user interface control for a side bar may be provided by a plugin, HTML controls, a Java application, or a native interface of the browser.

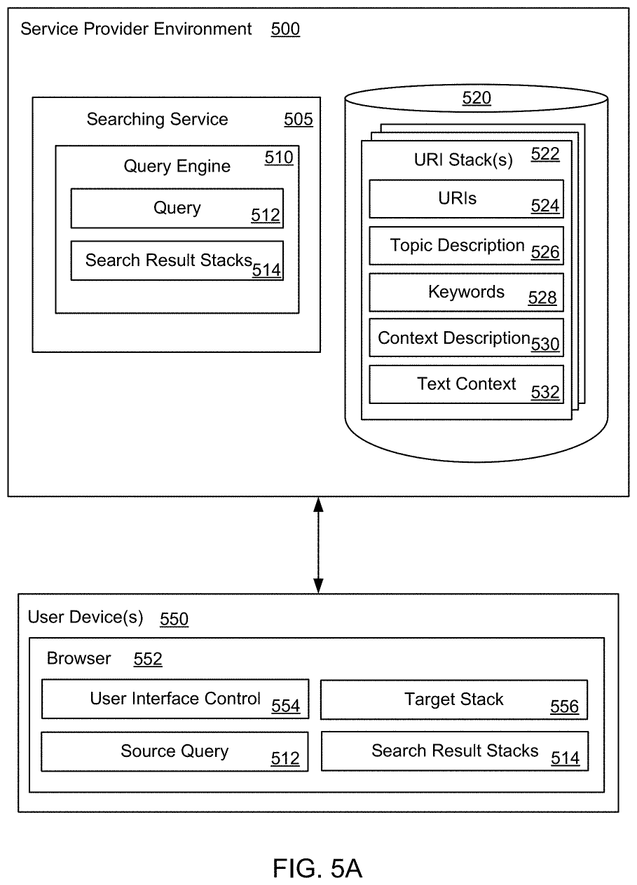

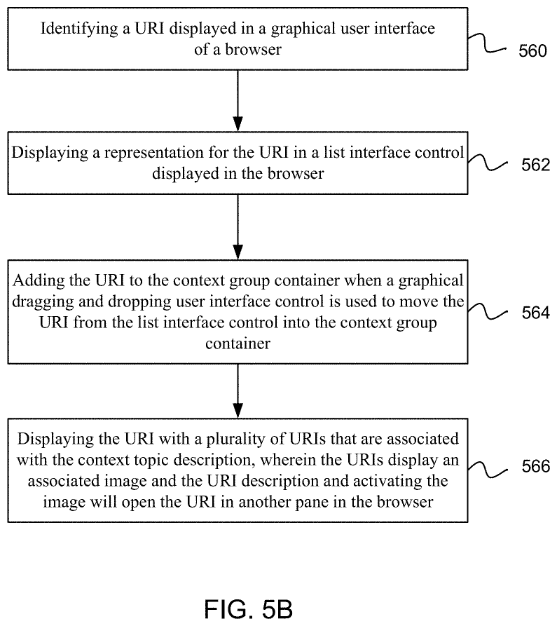

In another configuration, when a URI is viewed through the context group container then a user interface may be presented to capture or add a note for a URI. This may be a separate window to insert notes, a right click menu or another method of accessing user interface controls to add notes. The user interface may receive a note with a callout associated with a URI being viewed and a URI marker may be added by a user to reference a displayable portion of an electronic page. The note, a callout definition (e.g., a definition of the callout's appearance) and a URI marker may be stored in a context record for a URI in the context group container in a data store in cloud storage or on a server. The note, callout and URI marker may be displayed using sidebars, overlays, pop-up windows, transparent popup windows, or transparent icons generated by a plugin in a browser or an application when the URI is displayed in the browser. FIG. 5A illustrates an example of a system and related operations for searching for and finding a URI stack 522 or context group container which are stored with other URI stacks 522. A searching service 505 operating in a service provider environment 500 may include or communicate with a query engine 510 to generate a listing of search result stacks 514 related to a source query 512 containing search keywords. More specifically, the query engine 510 may obtain the search result stacks 514 by performing a search for the search terms in the source query 512 against a data store 520 accessible to the searching service 505, where the data store 520 includes a plurality of URI stacks 522. The searching service 505 may provide the search result stacks 514 to a browser 552 of a user device 550 where a listing of images can be displayed representing individual URI stacks. Specifically, the search results that are returned may be context group containers which may be accessed in order to access URIs associated with the context group containers (i.e., stacks).

The browser 552 may receive a selection of a target stack 556 from the search result stacks 514, and the browser 452 may retrieve an electronic page associated with the target stack 556 for display on the user device 550. A user that is searching for a stack or context group container of interest to the user may then view the context group container and the URIs in the context group container.

In one example, the data store 520 in the searching service 505 may include the URI stack(s) 522. The URI stacks 522 may also be referred to as context group containers or topic stacks, as the URI stacks 522 may be associated with a certain topic and/or title. Each URI stack 522 may include a plurality of URIs 524. In other words, the plurality of URIs 524 may be grouped together to form the URI stack 522. The plurality of URIs 524 in a given URI stack 522 may be related to a similar topic, theme, subject, category, key word, etc. The URI stack 522 may include a topic description 526. The topic description 526 may provide relational context for the URIs 524 in the URI stack 522 and explain a relationship between the URIs in the URI stack 522. The topic description 526 may describe the topic, theme, subject, category, etc. associated with the plurality of URIs 524 in the URI stack 522. The URI stack 522 may further include keywords 528 or tags to describe the nature of the plurality of URIs 524 in the URI stack 522. The URI stack 522 may further include a context description 530 and/or text context 532 for each URI to describe the nature of each of the plurality of URIs 524 in the URI stack 522.

In one example, the browser 552 may send the source query 512 to the searching service 505. The searching service 505 may receive the source query 512, and provide the source query 512 to the query engine 510. The query engine 510 may perform the search query for the source query 512 by searching or querying against the data store 520 containing the plurality of URI stacks 522 (or URI groupings which form the URI stacks 522). Thus, by querying against the plurality of URI stacks 522 using the source query 512, the query engine 510 may compare the source query 512 against elements of the URI stacks 522 (e.g., the URIs 524, topic descriptions 526, keywords 528, context descriptions 530, title, and/or text context 532) when executing the search query.

The query engine 510 may generate the search result stacks 514 as a search result, where the search result stacks 514 may be related to the source query 512. For example, the search result stacks 514 may have a similar topic description, keywords, context description, text context, etc. as compared to the search terms of the source query 512. The searching service 505 may provide the search result stacks 514 to the browser 552 of the user device 550. The browser 552 may receive the search result stacks 514, and in response, the browser 552 may display a user interface control 554 to indicate that stacks corresponding to the search result stacks 514 are available for selection and viewing. For instance, the user interface control 554 may be an icon on a browser plug-in bar or an icon on a browser control bar which can be selected to open an electronic page or a list box with the search results.

In one example, the user interface control 554 may be activated based on a selection by a user in the browser 552. For example, the user may select or click on the user interface control 554 displayed by the browser 552. In response to the user interface control 554 being activated, the browser 552 may display the list of the search result stacks 514 (i.e., the recommendation URIs). The user may select one of the search result stacks 514 on the list via the user interface of the browser 552, where the selected search result stack may correspond to the target stack 556. The browser 552 may receive the selection of the target stack 556, and the browser 552 may retrieve the electronic page associated with the target stack 556 for display.

The user device 550 may comprise a computer system that is embodied in the form of a desktop computer, a laptop computer, mobile devices, cellular telephones, smartphones, network-enabled televisions, tablet computer systems, or other devices with like capability.

The various processes and/or other functionality contained within the service provider environment 500 may be executed on one or more processors that are in communication with one or more memory modules. The service provider environment 500 may include a number of computing devices that are arranged, for example, in one or more server banks or computer banks or other arrangements. The computing devices may support a computing environment using hypervisors, virtual machine managers (VMMs) and other virtualization software.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

The content searching service 505 and the user device 550 may communicate via a network. The network may include any useful computing network, including an intranet, the Internet, a localized network, a wide area network, a wireless data network, or any other such network or combination thereof. Components utilized for such a system may depend at least in part upon the type of network and/or environment selected. Communication over the network may be enabled by wired or wireless connections and combinations thereof

FIG. 5A illustrates that certain processing modules may be discussed in connection with this technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, virtualized service environment, grid or cluster computing system. One or more API(s) may be provided for each module to enable a second module to send requests to and receive output from the first module. Such APIs may also allow third parties to interface with the module and make requests and receive output from the modules. While FIG. 5A illustrates an example of a system that may implement the techniques above, many other similar or different environments are possible. The example environments discussed and illustrated above are merely representative and not limiting.

FIG. 5B illustrates a method for storing a plurality of URIs (Universal Resource Identifier) in a context group container. The method includes the operation of identifying a URI displayed in a graphical user interface of a browser, as in block 560. The URI may be a URL that is being displayed in the browser to a user.

A representation for the URI may be displayed in a list interface control displayed in the browser, as in block 562. For example, all the URLs or links currently opened by a user in a web browser may be copied by a plug-in in the browser into the list interface control for the user to view. This list interface control may be displayed on any edge of the browser windows. For example, the list interface control may be on the right, left, top or bottom edge of the browser window. The list interface control may be generated by the plug-in that is loaded into the browser from a marketplace provided by the browser developer or the plug-in may be “side loaded” from an internet website or a computer readable medium (e.g., a Flash memory).

A context group container capable of storing a copy of the URI with the plurality of URIs can be displayed. The context group container may have a context topic description for the plurality of URIs. For example, if the context group container has the description “Improving your golf swing.” then a user may expect the URI contained within the context group container will relate to golf. The context group container may also have a simple title. For example, the title may be “Golf Swing”. This title may be part of the context topic description or the title may be a separate field that is stored for the context group container. In another example, the context topic description may be a topic keyword, a topic phrase, a topic question, a topic image, a topic video, a topic audio or another item that defines a topic.

The URI may be added to the context group container when a graphical dragging and dropping user interface control is used to move the URI from the list interface control into the context group container, as in block 564. For instance, the drag operation may start at the list interface control with one selected URI (or multiple selected URIs). Then the drag and drop operation may end at a location that is a group or listing of URIs in the context group container. This operation may enter the URI in the context group container or a section of URIs in the context group container. In an alternative configuration, the URI may be dragged into the context group container by dragging a tab in the browser into the context group container and this dragging of the tab will add the URI to the context group container or a section of the context group container.

An alternative user interface operation may be used to move the URI from the list interface control to the context group container. For example, the URI in the list interface control may be selected and a button or other user interface control operation may be used or triggered to move the URI to the context group container.

The URI may then be displayed with a plurality of URIs that are associated with the context topic description, as in block 566. The URIs may display an associated image and URI description. In addition, activating the image or a link grouped with the image may open the URI in another tab or pane in the browser. Thus, a copy of the URI or URL is stored with the image or a title. The URI can be displayed in screen proximity to the image and when activated the system can re-open the URI or URL in a tab or pane of the browser.

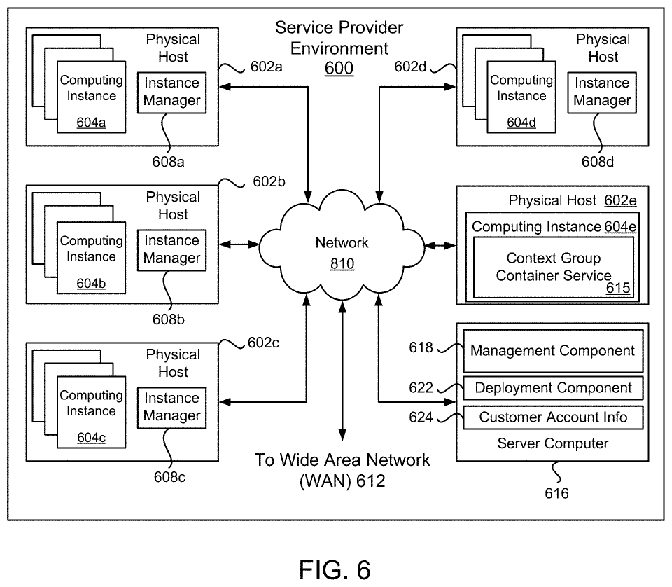

FIG. 6 is a block diagram illustrating an example service provider environment 600 that may be used to execute and manage a number of computing instances 604a-e. In particular, the service provider environment 600 depicted illustrates one environment in which the technology described herein may be used. The service provider environment 600 may be one type of environment that includes various virtualized service resources that may be used, for instance, to host computing instances 604a-e.

The service provider environment 600 may be capable of delivery of computing, storage and networking capacity as a software service. In one example, the service provider environment 600 may be established for an organization by or on behalf of the organization. That is, the service provider environment 600 may offer a “private cloud environment.” In another example, the service provider environment 600 may support a multi-tenant environment, wherein a plurality of customers may operate independently (i.e., a public cloud environment). Generally speaking, the service provider environment 600 may provide the following models: Infrastructure as a Service (“IaaS”), network-accessible system as a service, and/or Software as a Service (“SaaS”). Other models may be provided. For the IaaS model, the service provider environment 600 may offer computers as physical or virtual machines and other resources. The virtual machines may be run as guests by a hypervisor, as described further below. The network-accessible system as a service model delivers a computing system that may include an operating system, programming language execution environment, database, and web server.

Application developers may develop and run software solutions in the service provider environment 600 without incurring the cost of buying and managing the underlying hardware and software. The SaaS model allows installation and operation of application software in the service provider environment 600. End customers may access the service provider environment 600 using networked client devices, such as desktop computers, laptops, tablets, smartphones, etc. running web browsers or other lightweight client applications, for example. Those familiar with the art will recognize that the service provider environment 600 may be described as a “cloud” environment.

The particularly illustrated service provider environment 600 may include a plurality of physical hosts 602a-e. While four server computers are shown, any number may be used, and large data centers may include thousands of server computers. The service provider environment 600 may provide computing resources for executing computing instances 604a-e. Computing instances 604a-e may, for example, be virtual machines. A virtual machine may be an instance of a software implementation of a machine (i.e. a computer) that executes applications like a physical machine. In the example of a computing instance 604a-e, each of the physical hosts 602a-e may be configured to execute an instance manager 608a-d (including the physical host where the instance manager is not shown) capable of executing the computing instances 604a-e. The instance manager 608a-d may be a hypervisor, virtual machine monitor (VMM), or another type of program configured to enable the execution of multiple computing instances 604a-e on a single server. Additionally, each of the computing instances 604a-e may be configured to execute one or more applications. For example, a computing instance 604e may be used to execute a context group container service 615 to manage the context group containers and the context that is generated for the containers.

One or more server computers 616 may be reserved to execute software components for managing the operation of the service provider environment 600 and the computing instances 604a-e. For example, a server computer 616 may execute a management component 618. A customer may access the management component 618 to configure various aspects of the operation of the computing instances 604a-e purchased by a customer. For example, the customer may setup computing instances 604a-e and make changes to the configuration of the computing instances 604a-e.

A deployment component 622 may be used to assist customers in the deployment of computing instances 604a-e. The deployment component 622 may have access to account information associated with the computing instances 604a-e, such as the name of an owner of the account, credit card information, country of the owner, etc. The deployment component 622 may receive a configuration from a customer that includes data describing how computing instances 604a-e may be configured. For example, the configuration may include an operating system, provide one or more applications to be installed in computing instances 604a-e, provide scripts and/or other types of code to be executed for configuring computing instances 604a-e, provide cache logic specifying how an application cache should be prepared, and other types of information. The deployment component 622 may utilize the customer-provided configuration and cache logic to configure, prime, and launch computing instances 604a-e. The configuration, cache logic, and other information may be specified by a customer accessing the management component 618 or by providing this information directly to the deployment component 622.

Customer account information 624 may include any desired information associated with a customer of the multi-tenant environment. For example, the customer account information may include a unique identifier for a customer, a customer address, billing information, licensing information, customization parameters for launching instances, scheduling information, etc. As described above, the customer account information 624 may also include security information used in encryption of asynchronous responses to API requests. By “asynchronous” it is meant that the API response may be made at any time after the initial request and with a different network connection.

A network 610 may be utilized to interconnect the service provider environment 600 and the physical hosts 602a-e, 616. The network 610 may be a local area network (LAN) and may be connected to a Wide Area Network (WAN) 612 or the Internet, so that end customers may access the service provider environment 600. The network topology illustrated in FIG. 6 has been simplified, many more networks and networking devices may be utilized to interconnect the various computing systems disclosed herein.

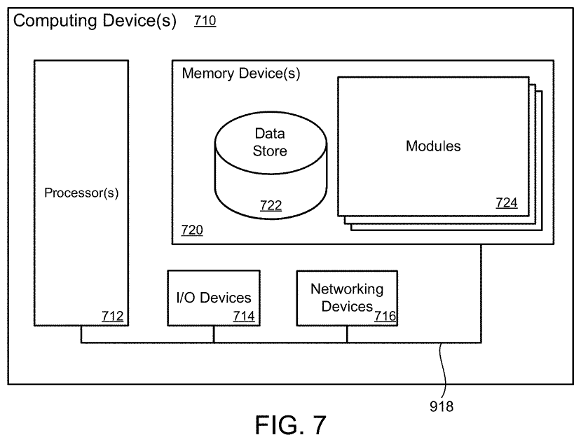

FIG. 7 illustrates a computing device 710 on which modules of this technology may execute. A computing device 710 is illustrated on which a high-level example of the technology may be executed. The computing device 710 may include one or more processors 712 that are in communication with memory devices 720. The computing device 710 may include a local communication interface 718 for the components in the computing device. For example, the local communication interface 718 may be a local data bus and/or any related address or control busses as may be desired.

The memory device 720 may contain modules 724 that are executable by the processor(s) 712 and data for the modules 724. For example, the memory device 720 may include a central metrics service module and other modules. The modules 724 may execute the functions described earlier. A data store 722 may also be located in the memory device 720 for storing data related to the modules 724 and other applications along with an operating system that is executable by the processor(s) 712.

Other applications may also be stored in the memory device 720 and may be executable by the processor(s) 712. Components or modules discussed in this description that may be implemented in the form of software using high-level programming languages that are compiled, interpreted or executed using a hybrid of the methods.

The computing device may also have access to I/O (input/output) devices 714 that are usable by the computing devices. Networking devices 716 and similar communication devices may be included in the computing device. The networking devices 716 may be wired or wireless networking devices that connect to the internet, a LAN, WAN, or other computing network.

The components or modules that are shown as being stored in the memory device 720 may be executed by the processor(s) 712. The term “executable” may mean a program file that is in a form that may be executed by a processor 712. For example, a program in a higher level language may be compiled into machine code in a format that may be loaded into a random access portion of the memory device 720 and executed by the processor 712, or source code may be loaded by another executable program and interpreted to generate instructions in a random access portion of the memory to be executed by a processor. The executable program may be stored in any portion or component of the memory device 720. For example, the memory device 720 may be random access memory (RAM), read only memory (ROM), flash memory, a solid-state drive, memory card, a hard drive, optical disk, floppy disk, magnetic tape, or any other memory components.

The processor 712 may represent multiple processors and the memory device 720 may represent multiple memory units that operate in parallel to the processing circuits. This may provide parallel processing channels for the processes and data in the system. The local communication interface 718 may be used as a network to facilitate communication between any of the multiple processors and multiple memories. The local communication interface 718 may use additional systems designed for coordinating communication such as load balancing, bulk data transfer and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for presenting a note for a URI (Universal Resource Identifier) linked to a context group container, comprising:
displaying the context group container with a plurality of URIs that are accessible via an application, wherein the context group container has a context topic description and topic title for the plurality of URIs;
receiving a selection of a URI for the context group container;
retrieving notes and URI markers that are associated with URI in a data store;
opening the URI in the application to display URI contents;
displaying a note for the URI in the application in a user interface control viewable with the URI in the application; and
displaying a URI marker which marks a portion of content of the URI and associating the note with the URI marker.

2. The method as in claim 1, further comprising marking the URI using a URI marker that is a graphical highlight to mark a portion of text in the URI.

3. The method as in claim 1, further comprising marking the URI using a URI marker that is a graphical highlight to mark a portion of an image in the URI.

4. The method as in claim 1, further comprising marking the URI using a URI marker that is a time marker for a video and the note include comments about the video.

5. The method as in claim 1 wherein the URI is opened in at least one of: a viewing pane or a tab of an application that is a browser, an electronic page of an application or an electronic page of a mobile application.

6. The method as in claim 1, further comprising opening the URI that is at least one of: an audio track, a podcast, an audio playlist, an image, a data file, a spreadsheet, an email, an application, a data object or an executable object that is be referenced by the URI.

7. The method as in claim 1, further comprising including a user name, user comment, and timestamp in the note.

8. The method as in claim 1, wherein a callout between the note and the URI marker is a graphical reference to associate the note with the URI marker.

9. The method as in claim 1, wherein a callout between the note and the URI marker is a graphical line.

10. The method as in claim 1, further comprising storing the URIs in a data store in a service provider environment as grouped by the context topic.

11. The method as in claim 1, wherein the note is displayed in a sidebar in a browser and the user interface control for a side bar is provided by a plugin or a native interface of the browser.

12. The method as in claim 1, wherein the context topic description is at least one of a topic keyword, topic phrase, topic question, topic image, topic video, or topic audio.

13. The method as in claim 1, further comprising:
receiving a context comment from a user about a URI, wherein the context comment explains a relationship between the context topic and the URI;
linking the context comment and the URI together in a data store; and
storing the context comment with a reference to the URI.

14. A non-transitory machine readable storage medium, for presenting a note for a URI (Universal Resource Identifier) stored in a context group container, including instructions embodied thereon, wherein the instructions, when executed by at least one processor, comprising:
displaying the context group container with a plurality of URIs that are viewable via a graphical user interface, wherein the context group container has a context topic description and topic title for the plurality of URIs;
receiving a selection of a URI from the context group container being presented in the graphical user interface;
retrieving notes and URI markers that are associated with URI;
opening the URI in the graphical user interface;
displaying a note including a user name, user comment, and timestamp with the URI in a user interface control viewable with the URI in the graphical user interface; and
displaying the URI marker which marks a portion of content of the URI and graphically associates the note with the URI marker.

15. The non-transitory machine readable storage medium of claim 14, wherein the graphical user interface is in at least one of: a browser, an application or a mobile application.

16. The non-transitory machine readable storage medium of claim 14, further comprising:
receiving a note with a callout associated with a URI being viewed, wherein the callout references a displayable portion of an electronic page;
storing the note and a callout definition with a context record for a URI in the context group container; and
displaying the note and callout in a sidebar generated by a plugin in a browser when the URI is displayed in the browser.

17. The non-transitory machine readable storage medium as in claim 14, further comprising:
receiving a context comment from a user about a URI, wherein the context comment explains a relationship between the context topic and the URI;
linking the context comment and the URI together in a data store; and
storing the context comment with a reference to the URI.

18. A system to present a note for a URI (Universal Resource Identifier) stored in a context group container, comprising:
at least one processor;
a memory device including instructions that, when executed by the at least one processor, cause the system to:
display the context group container with a plurality of URIs that are accessible via a browser, wherein the context group container has a context topic description and topic title for the plurality of URIs;
receive a selection of a URI from the context group container being viewed in the browser;
retrieve notes and URI markers that are associated with URI;
open the URI in the browser to display contents of the URI in the browser;
display a note for the URI in the browser in a user interface control viewable with the URI in a pane of the browser; and
display the URI marker which marks a portion of content of the URI and graphically associates the note with the URI marker.

19. The system as in claim 18, further comprising causing the system to: mark the URI using a URI marker that is at least one of: a graphical highlight to mark a portion of text in the URI, a time marker for a video, a time marker for an audio file, a image marker, a spatial maker for a 3D environment, a visual marker for an interface of an application.

20. The system as in claim 18, further comprising causing the system to: provide a call-out for the note referencing a highlighted portion of an electronic page that is displayed for the URIs.
